(19) United States
(12) Patent Application Publication
(10) Pub. No.: US 2006/0274957 A1
(43) Pub. Date: Dec. 7, 2006

(54) Information transmitting method for a remote operating system

(76) Inventors: Norio Suzuki, Yokohama (JP); Tsutomu Kontani, Hujisawa (JP); Yoshiko Sakanishi, Nakai (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/298,594

(22) Filed: Dec. 12, 2005

(30) Foreign Application Priority Data
Jun. 1, 2005 (JP) 2005-160868

(51) Int. Cl. G06K 9/36

(52) U.S. Cl. 382/239

(57) ABSTRACT

A data processing method is changed in accordance with the number pf colors in a bit map and the communication speed to thereby solve the problem in the background art. The number of colors used in the bit map is calculated. Image compression is performed by an appropriate compression method selected in accordance with the number of colors. Moreover, the image compression method is optimized in accordance with the communication speed between terminals in a remote operating system so that image quality can be prevented from being lowered in user's view. Accordingly, user's handling property and visibility can be kept good while the transfer size of image data can be reduced.

### INCORPORATION BY REFERENCE

This application relates to and claims priority from Japanese Patent Application No. 2005-160868 filed on Jun. 1, 2005 the entire disclosure of which is incorporated herein by reference.

### BACKGROUND OF THE INVENTION

The present invention relates to a system and method for transmitting screen data efficiently in a remote operating system having networks and computers connected to the networks.

A remote operating system is used so that an operating side terminal can operate an operated side remote terminal connected to the operating side terminal through a network. Specifically, the same contents as displayed on a display of the operated side terminal are displayed on a display of the operating side terminal so that the user's operation on the operating side terminal can be actually executed on the operated side terminal. As for a method for achieving the remote operating system, the contents (drawing data) displayed on the display of the operated side terminal are transferred from the operated side terminal to the operating side terminal so that the contents displayed on the display of the operated side terminal can be displayed on the display of the operated side remote terminal. Because the data are transferred as data to be drawn on a screen, the quantity of the data generally shows a tendency to become larger than the quantity of ordinary character-based data. For example, see Japanese Patent No. 2,753,277.

The percentage of mobile terminals to all terminals used in business activity has recently increased every year, so that there is an increasing tendency in network access through relatively low speed lines such as wireless LANs (Local Area Networks) or cellular phones compared with wire LANs. In such a low speed line environment between terminals in the remote operating system, a time delay however occurs in data transfer to the operating side terminal as described above when the quantity of data to be transferred is large. As a result, response of the display of the operated side terminal to the user's operation on the operating side terminal is lowered so that user's handling property is reduced remarkably. It is therefore preferable that the quantity of transfer data between terminals is reduced.

### SUMMARY OF THE INVENTION

Generally, reduction in quantity of transfer data causes deterioration in image quality. An object of the invention is to provide a remote operating system in which the quantity of transfer data between terminals can be reduced while display image quality can be kept good.

In the invention, the data processing method is changed in accordance with the number of colors in the bit map and the communication speed to thereby solve the problem in the background art. Specifically, an image on the display of the operated side terminal is divided by a size of 32×24 pixels. The divided bit maps are referred to as divided rectangles. Although here is the case where the size of 32×24 pixels is used, the image can be divided by an arbitrary size. The number of colors used is calculated from the bit map of each divided rectangle and a suitable compression method is used in accordance with the number of colors to compress the image. In the image compression method, optimization is performed in accordance with the communication speed between terminals in the remote operating system so that lowering of image quality in user's view can be suppressed. Accordingly, the user's handling property and visibility can be kept good while the transfer size of image data can be reduced.

According to the invention, lowering of image quality can be suppressed while the user's handling property can be kept good even in the case where the line between the operating side terminal and the operated side terminal in the remote operating system is a low/middle speed line. In addition, because the quantity of transfer data flowing in the network between terminals is reduced according to the invention, traffic between the terminals in the remote operating system can be reduced.

Other objects, features and advantages of the invention will become apparent from the following description of the embodiments of the invention taken in conjunction with the accompanying drawings.

### BRIEF DESCRIPTION OF THE DRAWINGS

FIG. 1 is a view showing the external appearance of a remote operating system;

FIG. 2 is a view showing a control sequence between a controller terminal and an agent terminal;

FIG. 3 is a view showing the module configuration of the controller terminal and the agent terminal and a flow of screen data;

FIG. 4 is a view showing the outline of a drawing data optimizing process executed by the agent terminal;

FIG. 5 is a flow chart showing a flow of a connection start process in the controller terminal;

FIG. 6 is a view showing an image transfer option setting table;

FIG. 7 is a flow chart showing a flow of the drawing data optimizing process in the agent terminal;

FIG. 8 is a flow chart showing a flow of a drawing data caching process in the agent terminal;

FIG. 9 is a flow chart showing a flow of data compression after the caching process in the agent terminal;

FIG. 10 is a flow chart showing a flow of processing in the case where the number of bitmap colors is larger than 16;

FIG. 11 is a view showing an example of queued drawing instructions;

FIG. 12 is a view showing a drawing data cache table; and

FIG. 13 is a view showing an example of the optimizing process for reducing the quantity of transfer data.

### DETAILED DESCRIPTION OF THE EMBODIMENTS

Preferred embodiments of the invention will be described below in detail with reference to the drawings.

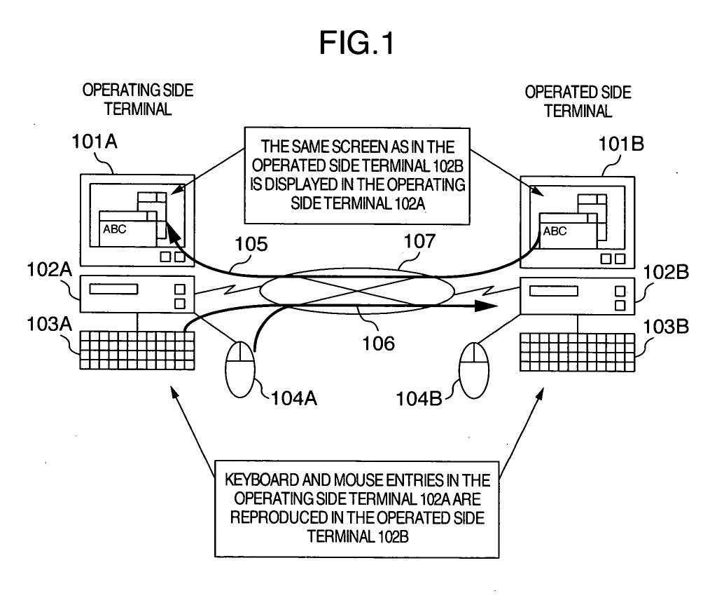

FIG. 1 shows the external appearance of a remote operating system according to an embodiment of the invention. A display 101A, a keyboard 103A and a mouse 104A are connected to an operating side terminal 102A. Similarly, a display 101B, a keyboard 103B and a mouse 104B are connected to an operated side terminal 102B. In a local area, a line such as an LAN can be used as a network 107. In the outside of the local area, a wireless communication line such as a wireless LAN, a cellular phone or a PHS (Personal Handyphone System) can be used as the network 107. The same screen as displayed on the operated side terminal 102B is displayed on the display 101A of the operating side terminal 102A. A flow of display data is represented by the arrow 105. Keyboard and mouse entries in the operating side terminal 102A are reproduced in the operated side terminal. A flow of input data is represented by the arrow 106. As each of the operating side terminal and the operated side terminal, a general-purpose personal computer may be used or an exclusive terminal may be provided. Even in the case where the display 101B, the keyboard 103B and the mouse 104B are not connected to the operated side terminal 102B, the operated side terminal 102B can be used likewise.

Description will be made while the operated side terminal is referred to as “agent terminal” and the operating side terminal as “controller terminal”.

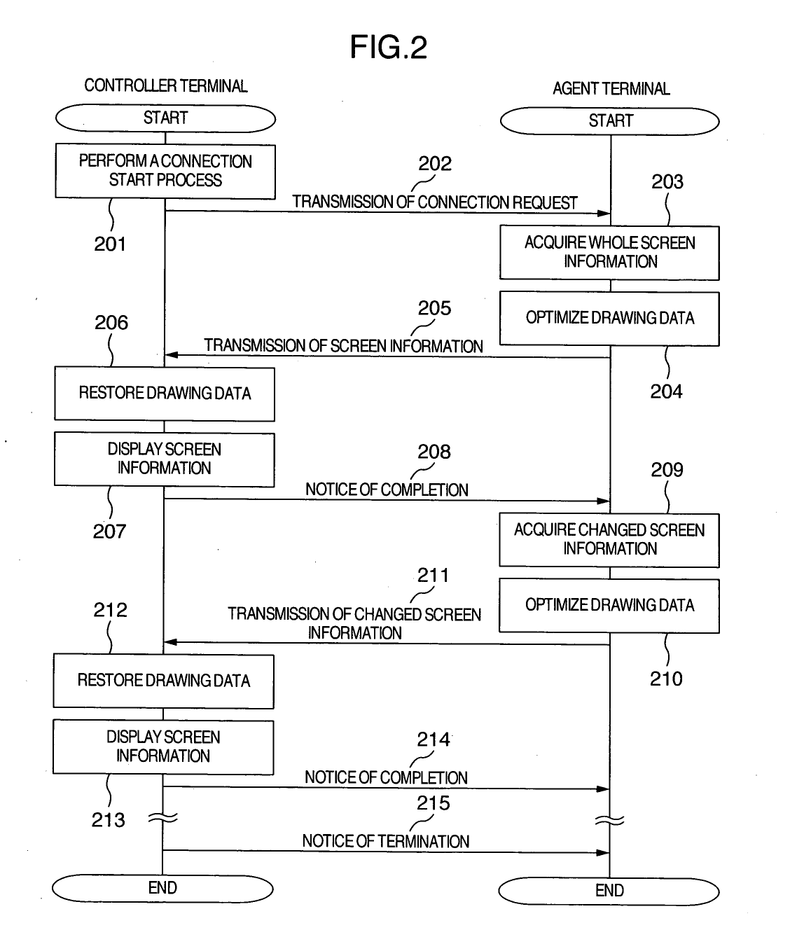

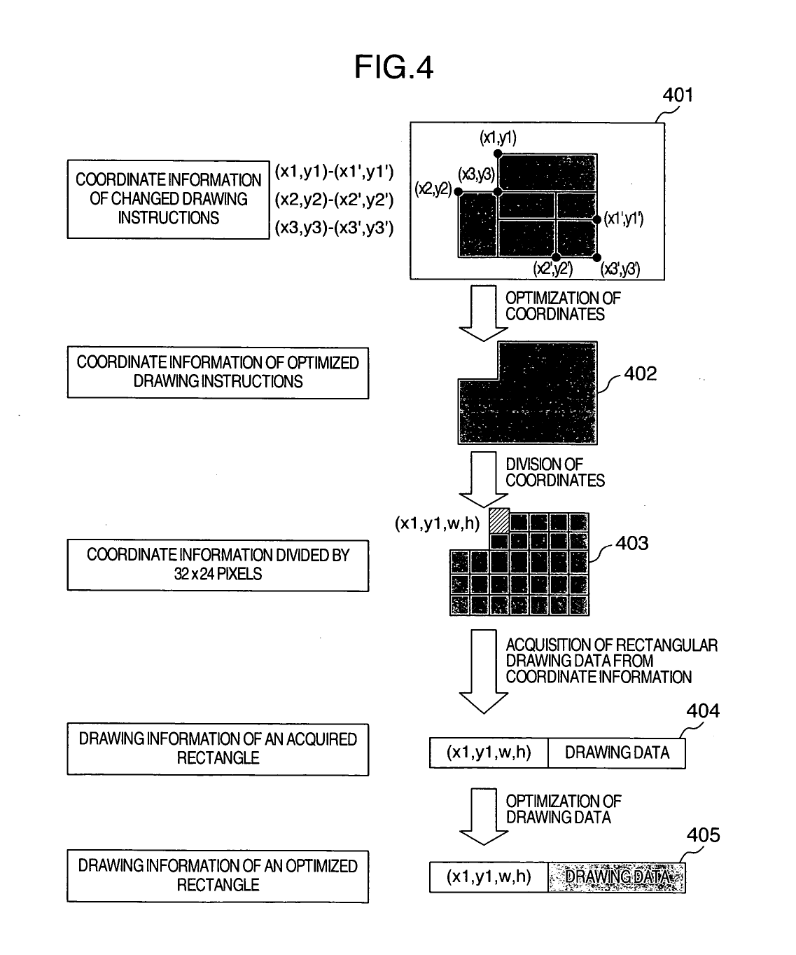

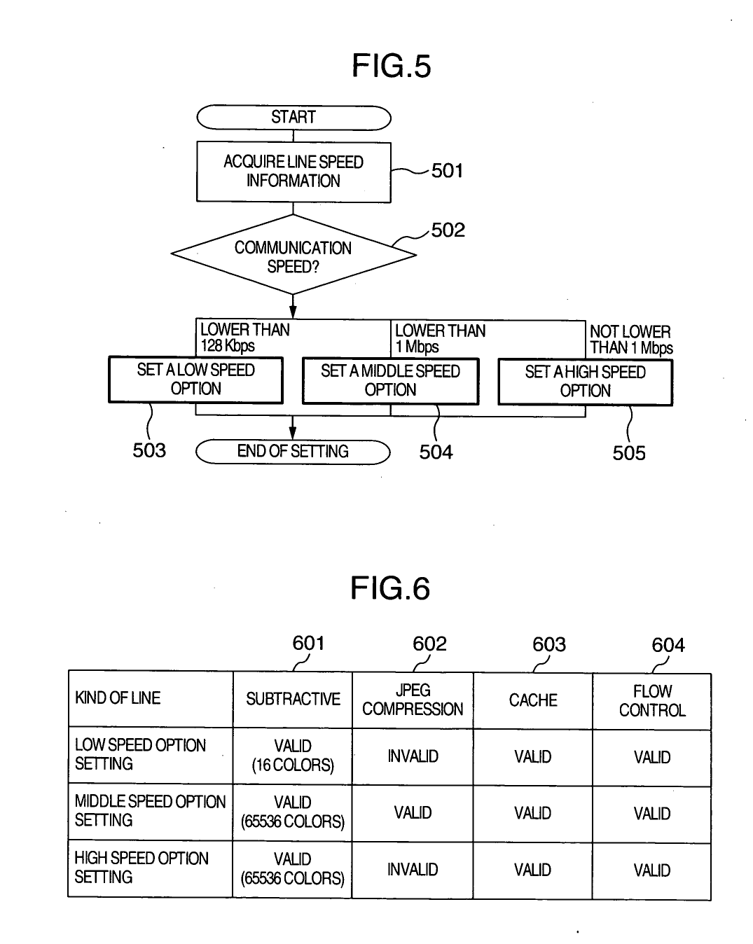

FIG. 2 diagrammatically shows a control sequence between a controller terminal and an agent terminal. When the controller terminal needs to be connected to the agent terminal, the controller terminal performs a connection start process 201 to select an optimum image transfer option in accordance with the communication line speed between the controller terminal and the agent terminal. The image transfer option will be described later with reference to FIGS. 5 and 6. The controller terminal transmits a connection request 202 to the agent terminal after adding setting option information selected in the connection start process 201 to the connection request 202. Upon reception of the connection request 202, the agent terminal acquires screen information of the agent terminal (203). All screen information acquired after the start of connection is subjected to a drawing data optimizing process 204. Acquisition of screen information and optimization of drawing instructions will be described later in detail with reference to FIG. 4 and FIGS. 7 to 13. The optimized drawing instructions are transmitted to the controller terminal (205). The optimized drawing instructions received by the controller terminal are restored in the same method as the optimizing method executed by the agent terminal (206). The restored drawing instructions are executed on an operating system so that screen information is displayed on the screen of the controller terminal (207). After the screen information is displayed, the controller terminal transmits a notice of completion 208 to the agent terminal.

Upon reception of the notice of completion 208, the agent terminal acquires screen information of a portion changed from the already transmitted screen information (209). The acquired screen information is subjected to a drawing instruction optimizing process and then transmitted to the controller terminal (210). The controller terminal performs restoration of the drawing instructions (211) and display of screen information on the screen (212) and then transmits a notice of completion 214 to the agent terminal. The series of screen information transfer procedures is repeated. Then, when the controller terminal transmits a notice of termination 215 to the agent terminal, transfer of screen information is terminated in the agent terminal so that communication between the controller terminal and the agent terminal is cut off.

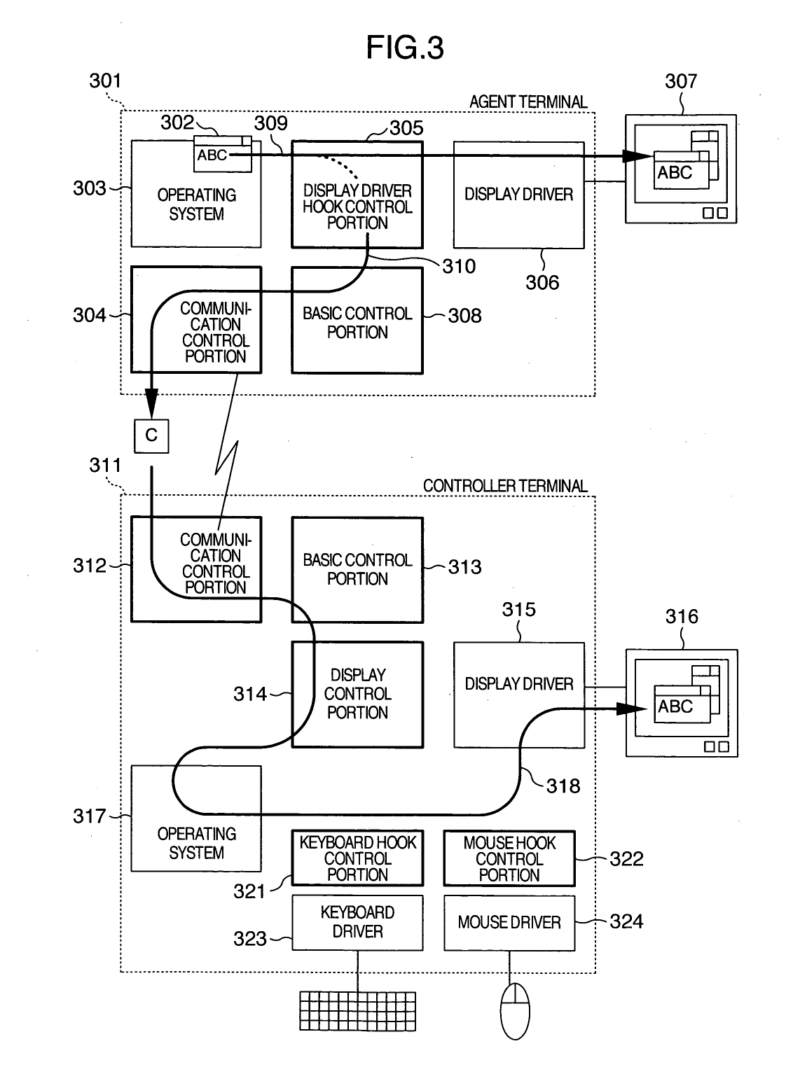

FIG. 3 shows the module configuration of a controller terminal and an agent terminal and a flow of screen data in this embodiment. Software operates in an agent terminal 301. The software includes a communication control portion 304 for controlling communication with a controller terminal 311, a display driver hook control portion 305 for catching drawing instructions given from an operating system 303 to a display driver 306, and a basic control portion 308 for controlling the respective control portions integrally to acquire drawing instructions from the display driver hook control portion and process the drawing instructions.

Software operates in the controller terminal 311. The software includes a communication control portion 312 for controlling communication with the agent terminal 301, a display control portion 314 for restoring the drawing instructions received from the agent terminal 301 and executing the drawing instructions on an operating system 317, a display driver 315 for displaying drawing data actually on the basis of the drawing instructions given from the operating system 317, a display 316 provided as a display medium, and a basic control portion 313 for controlling the respective control portions integrally.

The software operating on the controller terminal further includes a keyboard hook control portion 321 for catching keyboard data inputted from a keyboard driver 323 into the operating system 317, and a mouse hook control portion 322 for catching mouse data inputted from a mouse driver 324 into the operating system 317.

Operation data caught by the mouse hook control portion and the keyboard hook control portion are transmitted to the agent terminal through the communication control portion 312, so that the operation data are inputted into the operating system 303 on the agent terminal and executed on the operating system 303. The operating system 303 sends drawing instructions to the display driver 306 in response to the operation data, so that screen information is displayed on the display 307.

When drawing instructions 302 are given from the operating system 303 on the agent terminal, part of the drawing instructions corresponding to a changed screen data portion are caught in the display driver hook control portion (310). The caught drawing instructions are optimized by the basic control portion 308 and then transmitted to the controller terminal through the communication control portion 304. The basic control portion 314 on the controller terminal restores the transmitted drawing instructions to the drawing instructions caught by the display driver hook control portion. The restored drawing instructions are displayed on the display 316 through the operating system 317 and the display driver 315.

FIG. 4 is a view showing the outline of a drawing data optimizing process executed in the agent terminal. Among the drawing instructions caught in the display driver hook control portion 305, coordinate information is stored in a queue of the display driver hook control portion (401). The coordinate information is expressed in coordinate information (xn, yn) indicating top left vertices of rectangles and coordinate information (xn′, yn′) indicating bottom right vertices of the rectangles. The basic control portion 308 acquires coordinate information stored in the queue at regular intervals. When there are two or more pieces of coordinate information, the coordinate information is optimized so that an overlapping portion is eliminated from the coordinate information of the changed drawing instructions (402). When there is one piece of coordinate information stored in the queue, optimization is not executed. In the basic control portion 308, the optimized coordinate information is divided into rectangles of 32×24 pixels (403). The divided rectangle is given by a combination of coordinate information (xn, yn) indicating the top left vertex of the rectangle and (w, h) indicating the width and height of the divided rectangle. Then, a bit map in the rectangle is acquired from the divided rectangle information (404). Then, in order to reduce the quantity of the bitmap data, the number of colors used in the bit map is calculated so that the drawing data are compressed appropriately in accordance with the number of colors to perform optimization of the drawing information (405). The steps 403, 404 and 405 are repeated for all portions of changed drawing data.

Although this embodiment shows the case where the optimized coordinate information is divided by a size of 32×24 pixels, the optimized coordinate information may be divided by another size. The size information is stored in a storage device not shown in FIG. 3 but provided in each of the controller terminal and the agent terminal, so that the optimized coordinate information is divided by the predetermined size information read from the storage device. The predetermined size is standardized for the controller terminal and the agent terminal. Whenever the division size is changed, division size information is transmitted together with the divided drawing information.

FIG. 5 is a flow chart showing a flow of a connection start process in the controller terminal. In the controller terminal, the line speed between the controller terminal and the agent terminal is measured at the time of the start of connection to thereby calculate the communication speed (501). The communication speed can be also calculated on the basis of the communication speed set in the controller terminal. Then, the image transfer option setting is read in accordance with the calculated communication speed (502). The option is set so as to be optimized with respect to the handling property and visibility of the user in accordance with the communication speed in advance. A low speed option (503) for a communication speed lower than 128 Kbps, a middle speed option (504) for a communication speed lower than 1 Mbps, or a high speed option (505) for a communication speed not lower than 1 Mbps is selected as the image transfer option in accordance with the communication speed. An arbitrary value can be set as the value of the communication speed.

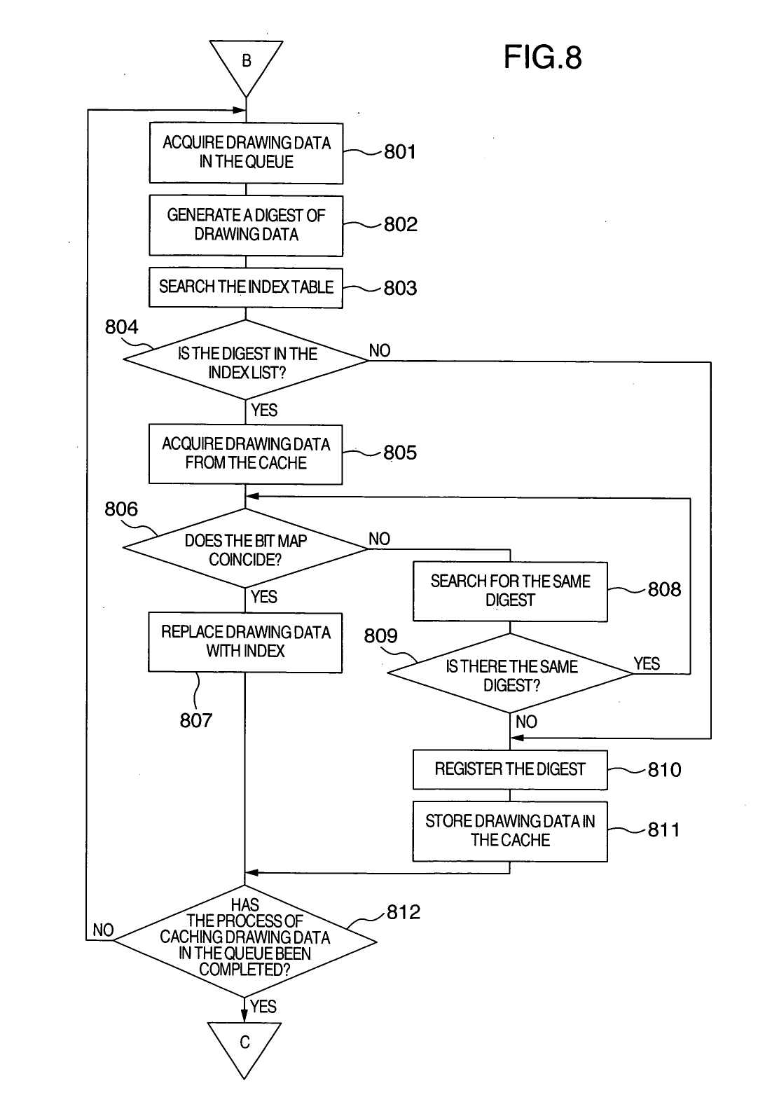

FIG. 6 is a table showing settings of options in accordance with the communication speed in the controller terminal. The table is stored in the storage device not shown in FIG. 3. In this embodiment, settings such as the number of subtractive colors 601 in a screen, application (valid/invalid) of JPEG compression 602 to the bit map, application (valid/invalid) of the cache 603 to the bit map and application (valid/invalid) of flow control 604 to transmission data are operated based on values optimized in accordance with the communication speed in advance in order to achieve the purpose of keeping the user's handling property and visibility good while reducing the transfer size of image data. The option of screen subtractive 601 is used so that the number of colors in the screen setting in the agent terminal is actually reduced to 4-16 bit colors to thereby reduce the quantity of data. The option of bitmap JPEG compression 602 is used so that compression using JPEG generally used as a bitmap data compression method is performed to reduce the quantity of data. The bitmap cache 603 will be described later with reference to FIG. 8. The flow control 604 of transmission data is validated when drawing information to be transmitted from the agent terminal to the controller terminal is transmitted after the agent terminal waits for reception of a notice of completion from the controller terminal. The flow control 604 is invalidated when the agent terminal transmits drawing information without waiting for reception of a notice of completion from the controller terminal. The contents of the option settings can be changed to arbitrary settings.

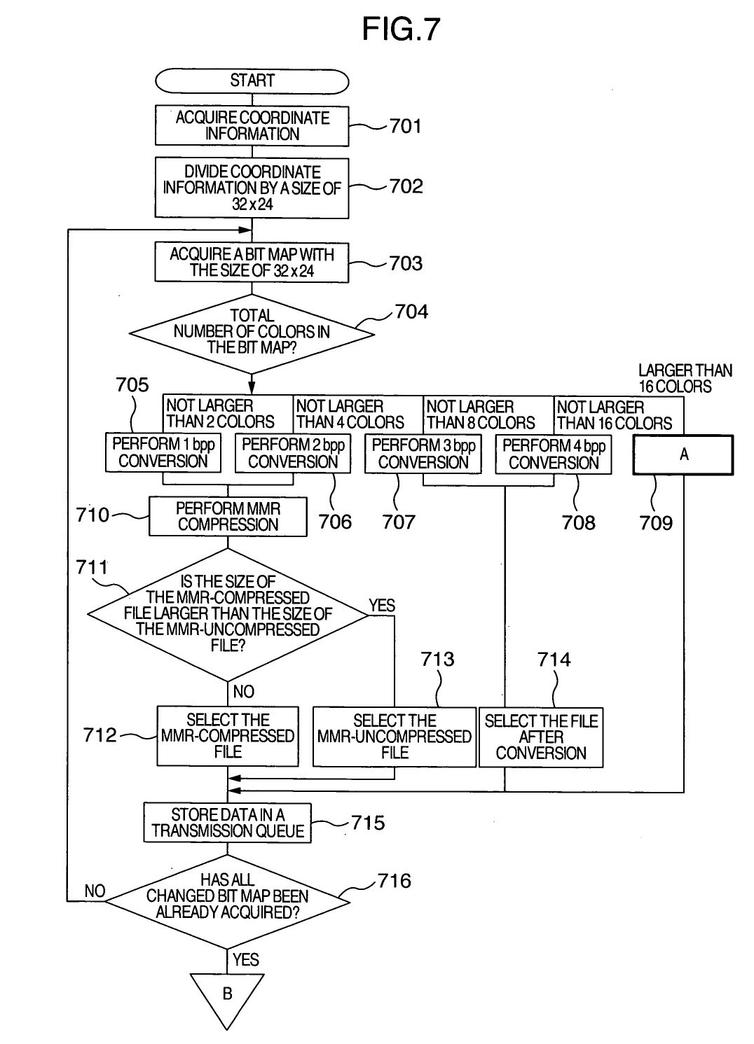

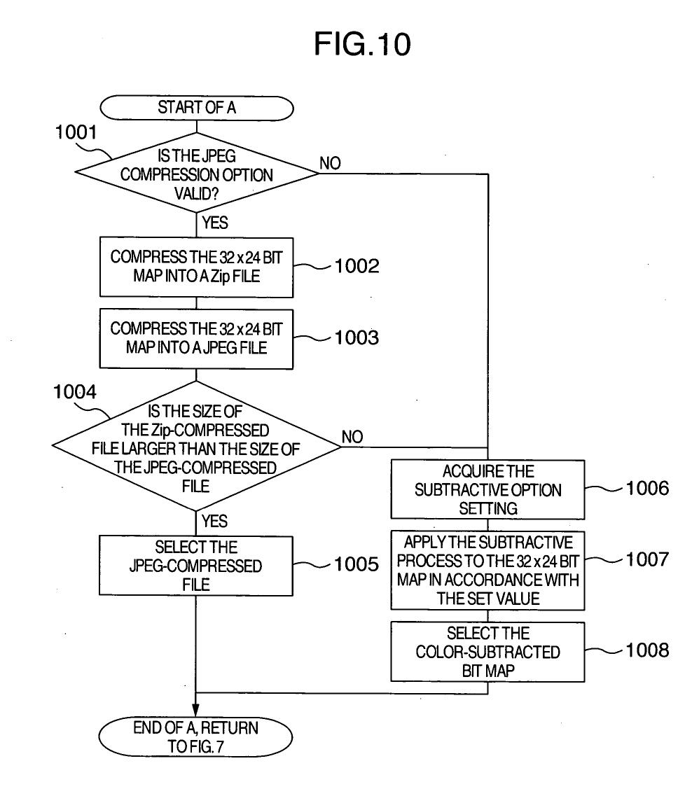

FIG. 7 is a flow chart showing a flow of the drawing data optimizing process in the agent terminal. The basic control portion 308 acquires coordinate information from at least one drawing data stored in the queue of the display driver hook control portion 305 (701). At least one piece of coordinate information acquired thus is optimized and divided into rectangles by a size of 32×24 pixels (702). Drawing data (bitmap file) are acquired from the acquired coordinate information of 32×24 pixels (703). The number of colors used is calculated from the acquired bit map and a bitmap file conversion method is selected in accordance with the number of colors (704). When the total number of colors in the bit map is not larger than 2, 1 bpp (bit per pixel) conversion is applied to the bitmap file (705). By the 1 bpp conversion, one pixel is replaced with 2-bit information and color information added to drawing data becomes 2-color data (color palette) so that the quantity of transfer data can be reduced. Similarly, when the total number of colors in the bit map is not larger than 4, 2 bpp conversion is applied to the bitmap file (706). When the total number of colors in the bit map is not larger than 8, 3 bpp conversion is applied to the bitmap file (707). When the total number of colors in the bit map is not larger than 16, 4 bpp conversion is applied to the bitmap file (708). In this manner, data can be converted into a necessary data format in accordance with the number of colors in the bit map, so that the quantity of data can be reduced while lowering of image quality can be suppressed. Processing in the case where the total number of colors in the bit map is larger than 16 will be described later with reference to FIG. 10.

Although 1 bpp conversion (705) or 2 bpp conversion (706) is performed when the total number of colors in the bit map is not larger than 4, MMR (Modified Modified Read) compression is applied to the bit map after conversion (710). Incidentally, though MMR compression brings expectation of reduction in quantity of data in accordance with the complexity and the number of colors in the bit map, there is a possibility that the quantity of data in the compressed file will be larger than the quantity of data in the uncompressed file because this conversion depends on the bitmap data. Therefore, the size of the MMR-compressed file is compared with the size of the MMR-uncompressed file (711). When the size of the MMR-compressed file is not larger than the size of the MMR-uncompressed file, the MMR-compressed file is selected (712). On the other hand, when the size of the MMR-compressed file is larger than the size of the MMR-uncompressed file, the MMR-uncompressed file is selected (713) on the basis of the judgment that the MMR compression is unsuitable. Incidentally, when the total number of colors in the bit map is not smaller than 8, the file after the bpp conversion is selected directly (714) because it is conceived that the complexity of the bit map is so high that the effect of MMR compression is low. After bitmap conversion and compression are performed in accordance with the number of colors in the aforementioned manner, coordinate information and drawing data are stored in the queue for transmission to the controller terminal (715). Then, a judgment is made as to whether conversion and compression of all divided bit maps have been already completed or not (716). When conversion and compression of all divided bit maps have been not completed yet, the steps of acquisition of the bit map (703), acquisition of the total number of colors, conversion and compression are repeated for the divided bit maps respectively.

FIG. 8 is a flow chart showing a flow of the drawing data caching process in the agent terminal. The basic control portion 308 acquires drawing data stored in the step 715 of FIG. 7 (801). A digest is generated from the acquired drawing data (802). Although a method for generating 16-byte data sampled from drawing data as a digest is used as a digest generating method, another method and another data size may be used. Then, searching is performed as to whether the drawing data in the queue have been already transmitted and are now present in the cache (803).

The basic control portion 308 stores drawing data transmitted to the controller terminal in the cache, so that drawing data are not transmitted but only index information of the cache is transmitted when the same drawing data need to be transmitted. The same cache is held in each of the agent terminal and the controller terminal. At the same time, digests are listed as indices of drawing data. For searching the cache, the digest is compared with the list of digests to check whether the same digest is present in the list or not (804). When the digest is present in the list, drawing data corresponding to the digest are acquired from the cache and drawing data in the queue are compared with drawing data in the cache (806). When the comparison shows that drawing data coincide with each other, drawing data in the queue are replaced with an index of the cache (807). When the comparison shows that drawing data do not coincide with each other, the same digest in the cache is searched for (808) to judge whether there is any digest or not (809).

When there is the same digest, drawing data in the cache are compared with drawing data in the queue again (806). When a decision is made in the step 809 that there is no digest, the digest is registered in the list (810) and the drawing data are stored in the cache (811) because a judgment is made that the drawing data have been not cached yet. Incidentally, when a decision is made in the step 804 that there is no same digest, the digest is registered (810) and the drawing data are stored in the cache (811) in the same manner as described above. The caching process of the steps 801 to 812 is repeated for respective drawing data in the queue.

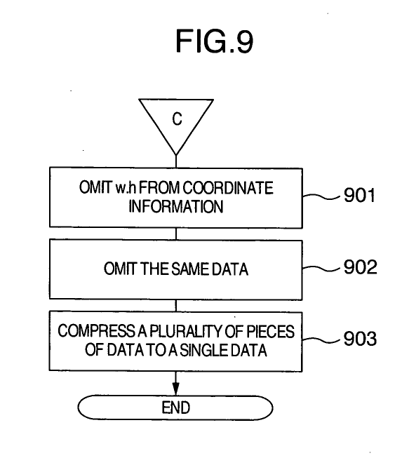

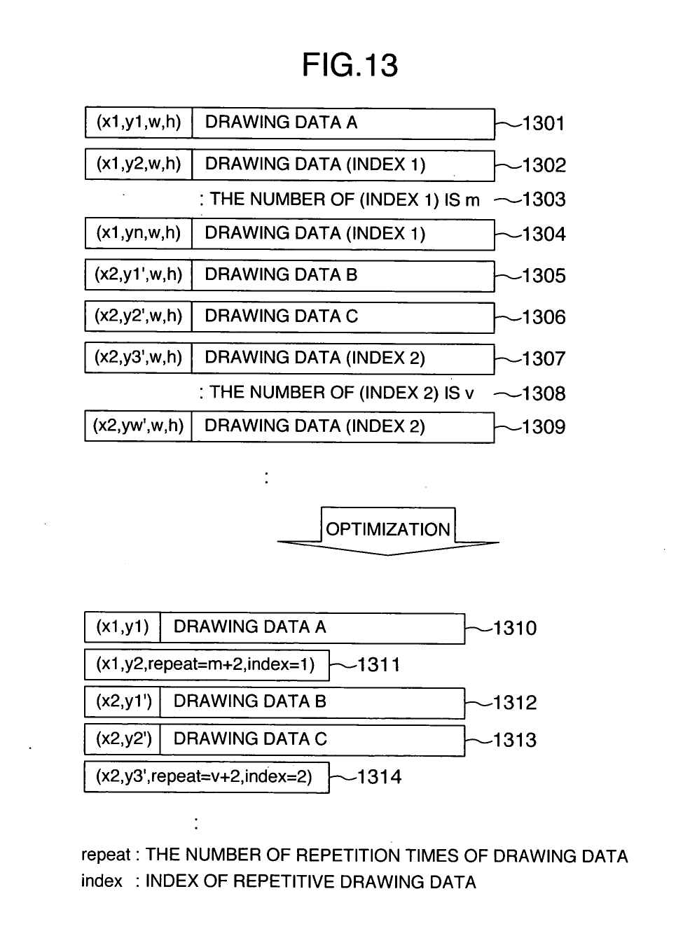

FIG. 9 is a flow chart showing a flow of data compression after the caching process in the agent terminal. The values of w and h in coordinate information are omitted (901) for drawing instructions in the queue after the caching process is completed in the step 812 in FIG. 8. Then, when drawing data are continuously present in the queue, the same data are omitted to perform optimization (902). Optimization of continuous same data will be described later with reference to FIG. 13. Finally, at least one optimized drawing instruction in the queue is zip-compressed into a single data (903).

FIG. 10 is a flow chart showing a flow of processing in the case where the number of colors in the bit map of drawing data in the agent terminal is larger than 16. A judgment is made as to whether the JPEG option is valid in the option setting or not (1001). When the JPEG option is valid (middle speed option setting), the bit map of 32×24 pixels is zip-compressed (1002). Then, the same bit map of 32×24 pixels is JPEG-compressed (1003). The size of the zip-compressed file is compared with the size of the JPEG-compressed file (1004). When the size of the zip-compressed file is larger than the size of the JPEG-compressed file, the JPEG-compressed file is selected (1005).

When the JPEG option is invalid (low speed or high speed option setting) or when the size of the zip-compressed file is not larger than the size of the JPEG-compressed file, the subtractive option setting is acquired (1006), the bit map of 32×24 pixels is subjected to a subtractive process with use of the set value (1007) and the bit map after the subtractive process is selected (1008). In these cases, the zip-compressed file used for comparison is discarded. It is unnecessary to store the zip-compressed file because the optimized drawing data will be zip-compressed collectively in the last (step 903 in FIG. 9).

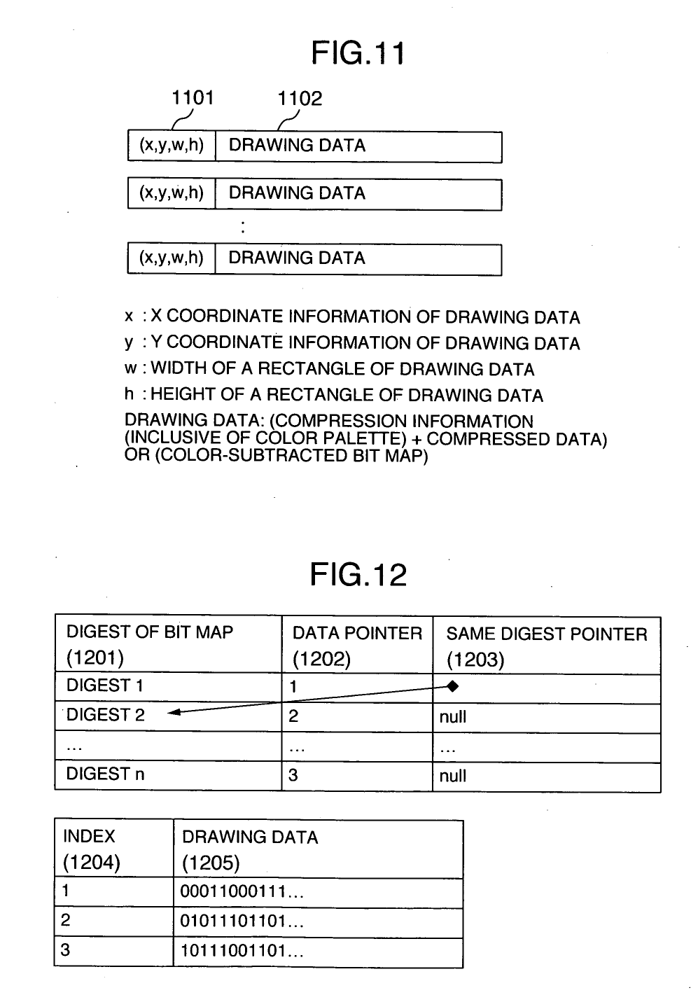

FIG. 11 shows an example of drawing instructions queued at a point of time that the bit map is divided by a size of 32×24 pixels and subjected to a subtractive process and a compression process in the agent terminal. At this point of time, each drawing instruction contains: (x, y, w, h) rectangular information (1011) having coordinate information, width and height; and drawing data (1102) subjected to a subtractive process and a compression process.

Each drawing data is provided as a combination of compression information (inclusive of color palette) and compressed data or as a bit map after the subtractive process. In the case of a compressed bit map, the bit map contains a flag indicating the bit map, a flag indicating the conversion method such as 1 bpp conversion, a flag indicating MRR conversion, color palette (2-color palette for 1 bpp conversion or 16-color palette for 4 bpp conversion) and data after conversion and compression. The bit map after the subtractive process contains a flag indicating the bit map, and data after the subtractive process.

In the case of a JPEG-compressed bit map, the bit map contains a flag indicating JPEG compression, and compressed data.

FIG. 12 shows a drawing data caching table. There are a digest table and an index table. The digest table contains a digest (1201) of drawing data, a data pointer (1202), and a same digest pointer (1203). The index table contains an index (1204), and drawing data (1205). As for these tables, quite the same tables can be generated by algorithm common to the agent terminal and the controller terminal.

In this embodiment, such table information is not transmitted in order to reduce the quantity of transfer data but a table generated by either of the agent terminal and the controller terminal can be transferred to the other as a table common to the agent terminal and the controller terminal.

In the agent terminal, when drawing data are the same as the drawing data registered in the table, the drawing data are replaced with an index and stored in the transmission queue. In the controller terminal, a process reverse to that in the agent terminal is performed so that actual drawing data are restored by searching on the basis of the index.

FIG. 13 shows an example of the drawing data processing method for further optimizing drawing data after the subtractive process, the compression process and the caching process in the agent terminal to reduce the quantity of transfer data.

Drawing data after the subtractive process, the compression process and the caching process are provided as a file or index after the compression process and the subtractive process. (1301) to (1304) are information displayed on one line because they are equal in X coordinate. In this embodiment, the values of Y coordinate, width and height are obtained by calculation because the width and height are fixed as w=32 pixels and h=24 pixels.

First, the width and height are omitted from (1301) so as to be processed into (1310). Then, (1302) to (1304) are equal in X coordinate and index information. For this reason, a repeat counter (repeat) is provided and (1302) to (1304) are processed into (1311) so that repeated data can be omitted.

All drawing data are optimized in the same manner as described above.

The optimized drawing instructions are transmitted from the agent terminal to the controller terminal and restored by the basic control portion on the controller terminal. The kind of data is judged from the flag set in the head of the drawing data, so that restoration is performed in accordance with the kind of data. When a judgment is made from the flag set in the head of the drawing data that the data are a bit map file, the flag indicating MMR compression is judged. When the MMR compression flag is on, MMR-compressed data are uncompressed. When the MMR compression flag is off or after MMR-compressed data are uncompressed, it is unnecessary to perform the restoration process because the drawing data (bitmap file) can be processed directly by the operating system. Finally, the width w and height h of each drawing instruction which have been omitted are set so that drawing instructions are given to the operating system. When a judgment is made from the flag set in the head of the drawing data that the data are a JPEG file, the JPEG file is restored to a bitmap file, and the width w and height h of each drawing instruction which have been omitted are set so that drawing instructions are given to the operating system.

When an index and a repeat counter are present as represented by (1311), drawing data corresponding to the index are read from the cache table of the agent terminal, restoration is performed in the same manner as described above and drawing instructions are given to the operating system. Then, the same process is repeated by the number of times indicated by the repeat counter. Or the width w and height h may be calculated from the value of the repeat counter so that one drawing instruction can be executed.

Although this embodiment has shown the case where the optimized drawing data are collectively zip-compressed into a single data so that the single data can be transmitted, it is a matter of course that the compression method is not limited to the zip compression, and that another compression method may be used. In this case, the compression method used in the step 1002 in FIG. 10 can be replaced with the other compression method.

Although this embodiment has shown the case where the optimized coordinate information is divided into rectangles by a size of 32×24 pixels (403 in FIG. 4), selection of not a rectangle but three points from coordinates may be repeated so that the optimized coordinate information can be divided into triangles.

Although this embodiment has shown the case where the compression method is changed in accordance with the number of colors (FIG. 7) so that, for example, a JPEG compression is used when the number of colors is not smaller than 16, the rate of compression may be changed in accordance with the number of colors so that, for example, 80% is used as the rate of compression when the number of colors is not smaller than 32, and 60% is used as the rate of compression when the number of colors is not smaller than 64.

1. An information transmitting method in a remote operating system in which an operating side terminal operates an operated side terminal through a network, wherein the operated side terminal selects an image data compression method in accordance with the number of colors in image data, compresses the image data by the selected compression method and transmits the compressed image data to the operating side terminal.

2. An information transmitting method in a remote operating system according to claim 1, wherein the image data are respective image data obtained in such a manner that image data displayed on a display are divided by a predetermined size.

3. An information transmitting method in a remote operating system according to claim 1, wherein the image data are image data of portions changed between image data displayed on a display before the passage of a predetermined time and image data displayed on the display after the passage of the predetermined time.

4. An information transmitting method in a remote operating system according to claim 3, wherein the image data are respective image data obtained in such a manner that image data of the changed portions are divided by a predetermined size.

5. An information transmitting method in a remote operating system according to claim 1, wherein:
each of the operating side terminal and the operated side terminal has a cache; and
the operated side terminal transmits only index information of the image data to the operating side terminal when the image data to be transmitted to the operating side terminal are present in the cache of the operated side terminal.

6. An information transmitting method in a remote operating system according to claim 5, wherein the operating side terminal acquires image data corresponding to the index information from the cache of the operating side terminal when the operating side terminal receives the index information.

7. A remote operating system in which an operating side terminal operates an operated side terminal through a network, wherein the operated side terminal includes:
a basic control portion for selecting an image data compression method in accordance with the number of colors in image data and compressing the image data by the selected compression method; and
a communication control portion for transmitting the compressed image data to the operating side terminal.

8. A remote operating system according to claim 7, wherein the image data are respective image data obtained in such a manner that the basic control portion divides image data displayed on a display by a predetermined size.

9. A remote operating system according to claim 7, wherein the image data are image data of portions changed between image data displayed on a display before the passage of a predetermined time and image data displayed on the display after the passage of the predetermined time.

10. A remote operating system according to claim 9, wherein the image data are respective image data obtained in such a manner that the basic control portion divides the image data of the changed portions by a predetermined size.

11. A remote operating system according to claim 7, wherein:
each of the operating side terminal and the operated side terminal has a cache; and
the basic control portion judges whether the image data to be transmitted to the operating side terminal are present in the cache of the operated side terminal or not, so that the communication control portion transmits only index information of the image data to the operating side terminal when a decision is made that the image data are present in the cache.

12. A remote operating system according to claim 11, wherein the operating side terminal includes a basic control portion which acquires image data corresponding to the index information from the cache of the operating side terminal when the operating side terminal receives the index information.
